(19) United States
(12) Patent Application Publication
(10) Pub. No.: US 2025/0378722 A1
(43) Pub. Date: Dec. 11, 2025

(54) VEHICLE DIAGNOSTIC METHOD BASED ON MODE $06 AND IN-USE MONITOR PERFORMANCE RATIO DATA

(71) Applicant: Innova Electronics Corporation, Irvine, CA (US)

(72) Inventors: Phuong Pham, Fountain Valley, CA (US); Keith Andreasen, Garden Grove, CA (US); Danh Nguyen, Ho Chi Minh City (VN); Thuan Huynh, Ho Chi Minh City (VN)

(21) Appl. No.: 18/734,370

(22) Filed: Jun. 5, 2024

(51) Int. Cl. G07C 5/08; G07C 5/00

(52) U.S. Cl. CPC G07C 5/0816; G07C 5/008; G07C 5/0808; G07C 5/085

(57) ABSTRACT

An automotive diagnostic method aimed at focusing diagnostic data retrieval and analysis on a possible fault condition includes receiving vehicle data from a vehicle at a data acquisition and transfer device (DAT) and analyzing the vehicle data to identify a possible fault condition. A drive cycle associated with the identified possible fault condition is identified, and driving conditions are monitored to identify completion of the identified drive cycle. Upon completion of the identified drive cycle, vehicle data is analyzed to identify an abnormal monitor. Vehicle data is also analyzed to identify an abnormal value of In-Use Monitor Performance Ratio (IUMPR) associated with the abnormal monitor. When an abnormal value of IUMPR is identified, a likely diagnostic condition associated with the identified abnormal IUMPR is further identified.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a vehicle diagnostic system and method, and in particular, a vehicle diagnostic system and method aimed at identifying an underlying diagnostic issue that caused the triggering of a diagnostic fault code.

### 2. Description of the Related Art

The integration of computer systems into the automobile has resulted in automotive diagnostics including a data analysis component. In this regard, while historical vehicle diagnostics may have relied solely on a mechanic's assessment of what can be seen or heard during operation of the vehicle, the data provided by the contemporary vehicles allows for a much more comprehensive diagnostic assessment of the vehicle.

However, as vehicles evolve and more computers become integrated into the vehicle, using data to diagnose a vehicle may require a nuanced approach. For instance, diagnostic trouble codes (DTCs) are generated by contemporary vehicles when a problem has arisen in one or more components of the vehicle. Retrieving and reviewing the DTC(s) is certainly a useful part of a diagnostic process, particularly when the process is supported by historical data for vehicle specific resolution. However, relying solely on the DTC(s) may lead to ambiguous results, as the DTC(s) may be representative of a symptom based on an underlying, deeper diagnostic condition.

In addition to DTC(s), many modern vehicles may also be capable of generating live data for one or more sensors, systems, or other vehicle components. The live data may be representative of that vehicle component's performance during operation of the vehicle, and thus, the use of live data may be a useful tool when trying to diagnose a vehicle.

The large amounts of data that may be generated by the vehicle may lead to accurate, data-based diagnostic conclusions. However, undertaking the task of analyzing the vehicle data may be beyond the capabilities or interest of the common vehicle owner, and thus, in many instances, problems with the vehicle may be ignored. For instance, live data may be difficult to decipher without a better understanding of the operative relationship between various components. Even professional mechanics may struggle at analyzing the vehicle data to troubleshooting problem. The ability to understand how one piece of diagnostic data may or may not relate to other pieces of diagnostic data may be challenging, and as a consequence, if related data goes unnoticed, it is possible that diagnostic insights or cues may be overlooked.

Furthermore, a diagnostic analysis of the vehicle may be enhanced by causing a prescribed action for one or more vehicle components, such as causing a valve to open or close. The prescribed action may be associated with an expected result, which may be observable in the live data. However, as noted above, being able to digest live data reading in the context of a comprehensive diagnostic data package may prove to be challenging.

Accordingly, there is a need in the art for a diagnostic system that provides an easy to use diagnostic system that may present diagnostic data in a easy to understand format, which may also facilitate processing of live data resulting from prescribed actions as part of a diagnostic assessment of the vehicle. Various aspects of the present disclosure address this particular need, as will be discussed in more detail below.

### BRIEF SUMMARY

According to one embodiment, there is provided an automotive diagnostic method aimed at focusing diagnostic data retrieval and analysis on a possible fault condition. The method includes receiving vehicle data from a vehicle at a data acquisition and transfer device (DAT) and analyzing the vehicle data to identify a possible fault condition. A drive cycle associated with the identified possible fault condition is identified, and driving conditions are monitored to identify completion of the identified drive cycle. Upon completion of the identified drive cycle, vehicle data is analyzed to identify an abnormal monitor. Vehicle data is also analyzed to identify an abnormal value of In-Use Monitor Performance Ratio (IUMPR) associated with the abnormal monitor. When an abnormal value of IUMPR is identified, a likely diagnostic condition associated with the identified abnormal IUMPR is further identified.

When normal value of IUMPR may be identified, the method may additionally include the step of retrieving Mode $06 data. The Mode $06 data may be reviewed for an abnormal test result and the component associated with the abnormal test result may be identified. The method may also include step of initiating a Special Test for the component associated with the abnormal test result.

The step of analyzing vehicle data to identify a possible fault condition may be based on an analysis of at least one diagnostic trouble code (DTC) included in the received vehicle data.

The step of analyzing vehicle data to identify a possible fault condition may be based on an analysis of live data included in the received vehicle data.

The step of analyzing vehicle data to identify an abnormal value of IUMPR may include analyzing a conditions item portion of IUMPR. The step of analyzing vehicle data may occur at the DAT. The step of analyzing vehicle data to identify an abnormal value of IUMPR includes analyzing a completion item portion of IUMPR.

The step of analyzing vehicle data may include using a machine learning model, wherein vehicle data is entered into the machine learning model to produce the possible fault condition.

The method may additionally include the step of analyzing the received diagnostic data to identify at least one of a monitor ID and test ID when no abnormal IUMPR is identified.

The step of analyzing the vehicle data to identify a possible fault condition may occur at the DAT.

All steps following the receipt of vehicle data may occur autonomously in response to receipt of the vehicle data.

All steps following completion of the identified drive cycle may occur autonomously in response to identification of the completed drive cycle.

The method may also include the step of generating a signal for wireless communication to a remote electronic device, with the signal including the identified likely diagnostic condition.

The method may further comprise the step of assigning a reliability score to the possible fault condition. The steps of identifying the drive cycle and monitoring driving conditions may only occur if the reliability score is above a prescribed threshold.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIGS. 1A-1C depict a flow chart of one embodiment of a data driven vehicle diagnostic method;

FIG. 2 is a schematic of a system configured to implement one embodiment of the data driven vehicle diagnostic method;

FIGS. 3A-3B are charts depicting exemplary monitors supported in Mode $09, PID 08 and PID OB-IUMPR for spark ignition engines;

FIG. 4 is a chart depicting exemplary monitors supported in Mode $09, PID 08 and PID OB-IUMPR for compression ignition engines;

FIG. 5 is a chart providing information related to continuous monitors that may run on a vehicle;

FIG. 6 is a chart providing information related to continuous monitors that may run on a vehicle;

FIG. 7 is a flow chart of an exemplary methodology associated with implementing a special function test; and

FIG. 8-10 relate to an exemplary use of the present methodology.

Common reference numerals are used throughout the drawings and the detailed description to indicate the same elements.

### DETAILED DESCRIPTION

The detailed description set forth below in connection with the appended drawings is intended as a description of certain embodiments of data-based vehicle diagnostics and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to an automotive diagnostic system and related methodology that analyzes vehicle data to derive a possible vehicle fix. When one or more Diagnostic Trouble Codes (DTCs) are triggered by the vehicle's electrical system, that is typically indicative of a problem in one or more vehicle components. A diagnostic tool may be used to retrieve the DTCs, as well as readiness monitors, Mode $06 monitors and In-Use Monitor Performance Ratio (IUMPR) counter data. The diagnostic method may check the Readiness Monitor status and then verify the test result via Mode $06 monitors and IUMPR counter data. A drive cycle may be added to this function to assist the user in driving the vehicle under the condition so that the Readiness Monitors can be completed. This verification step may allow for checking the status of the component in Mode $06 to detect if the component is good or not.

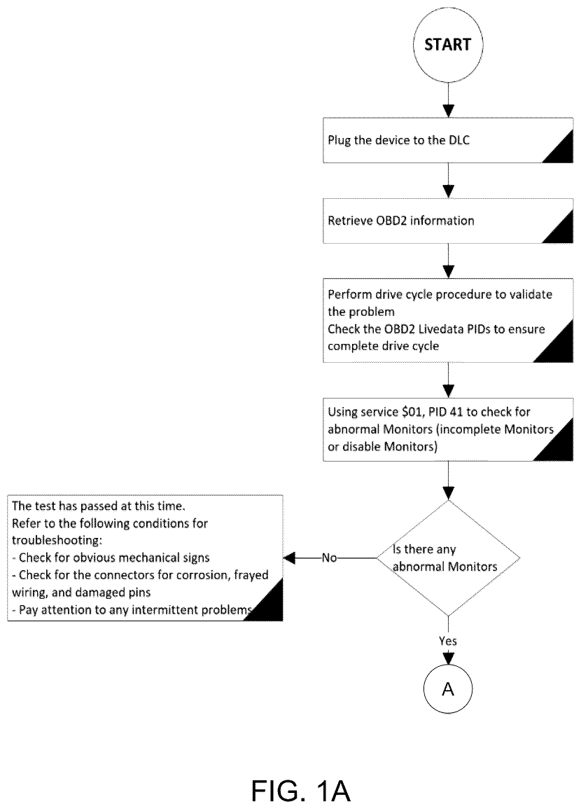

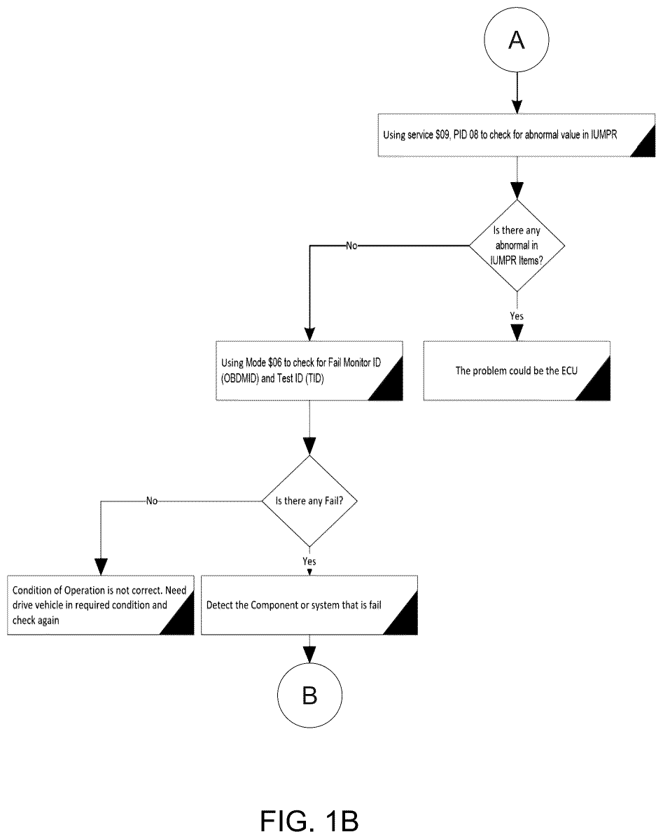

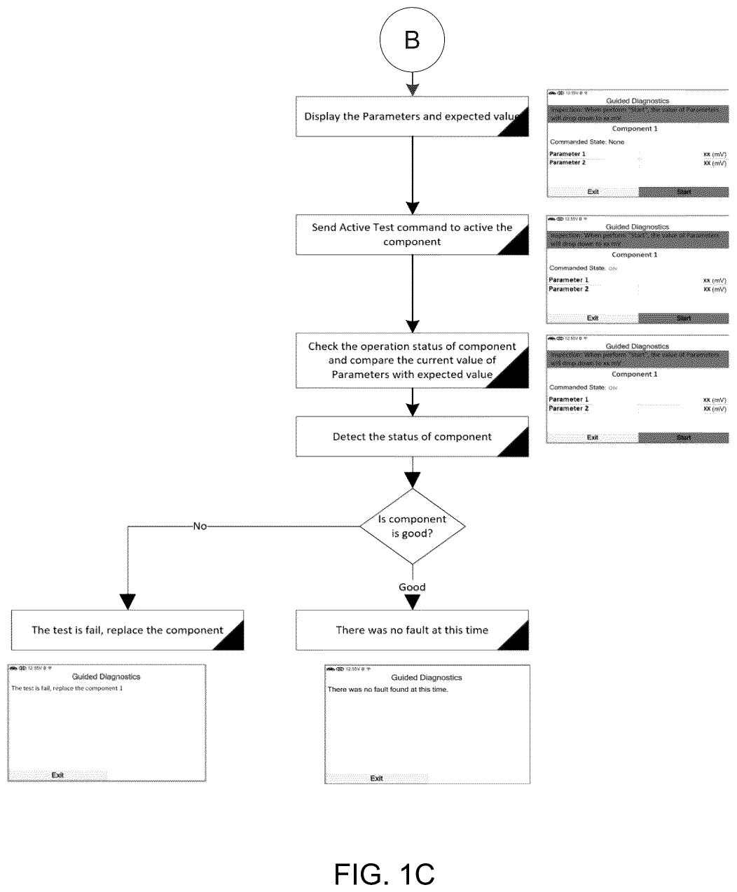

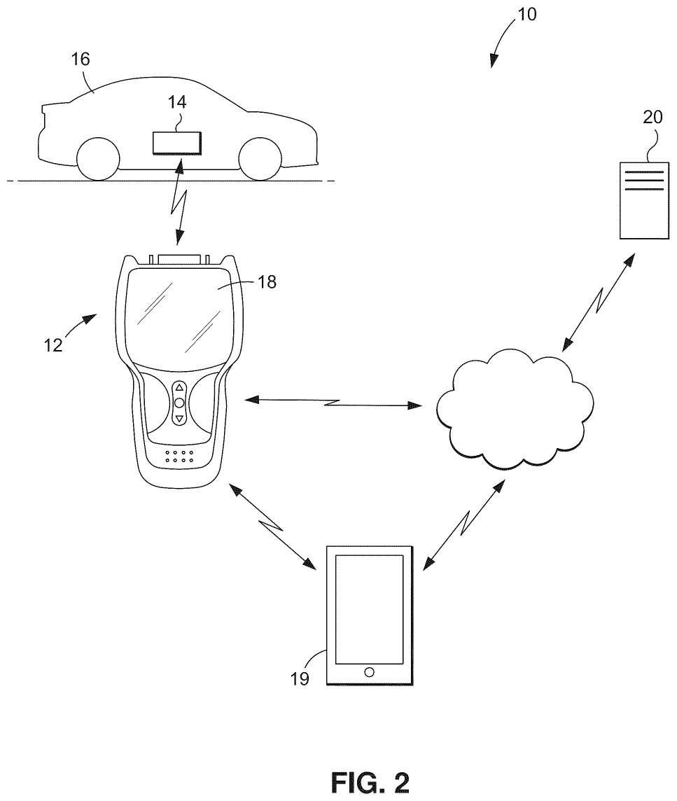

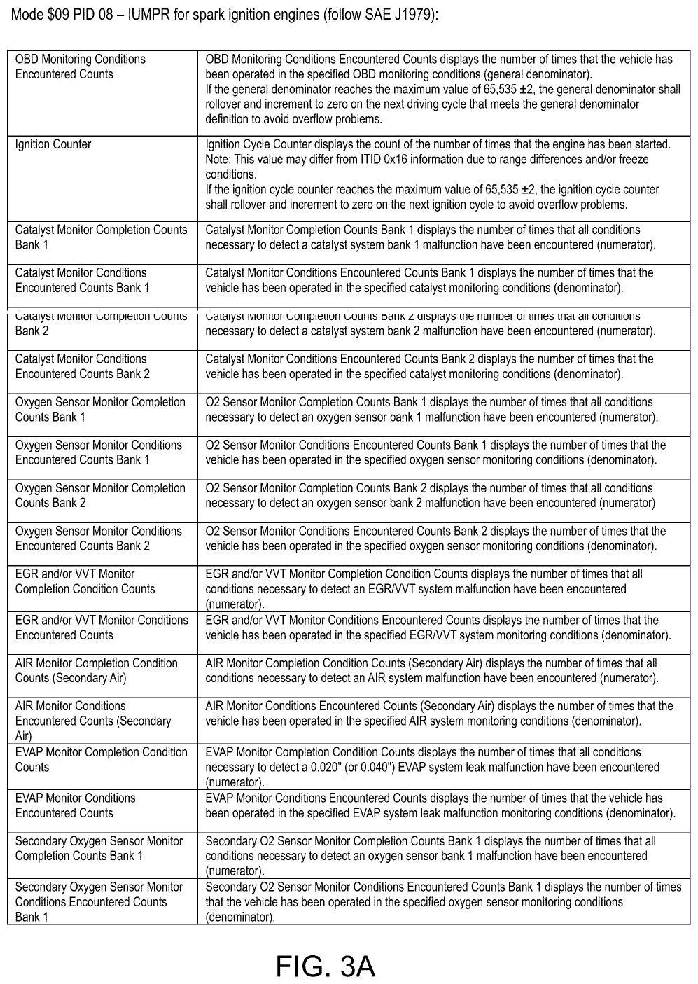

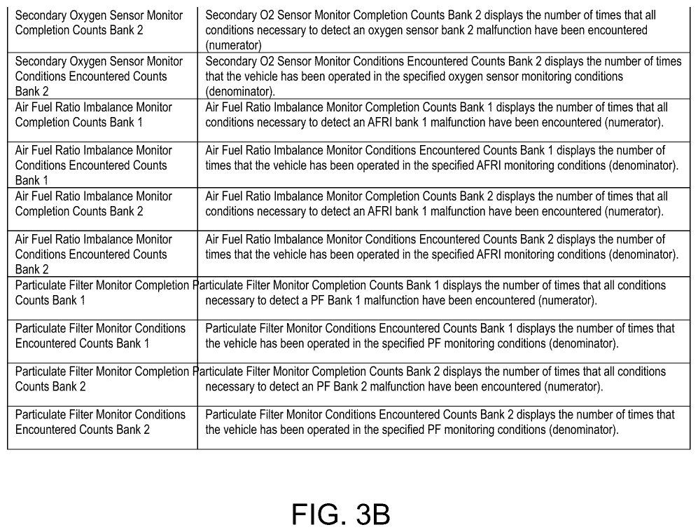

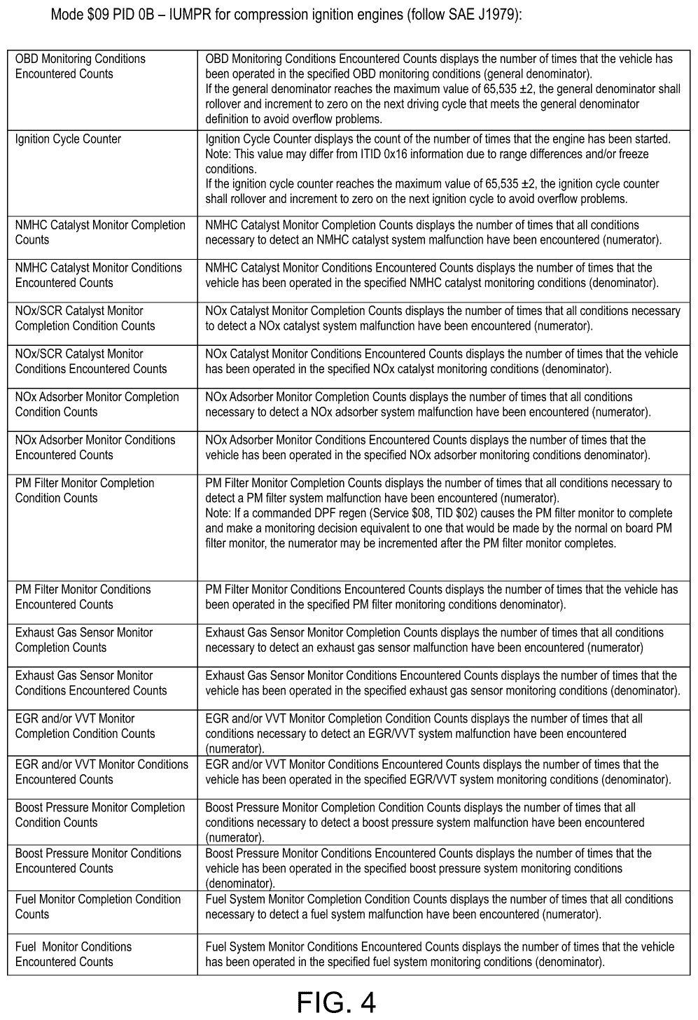

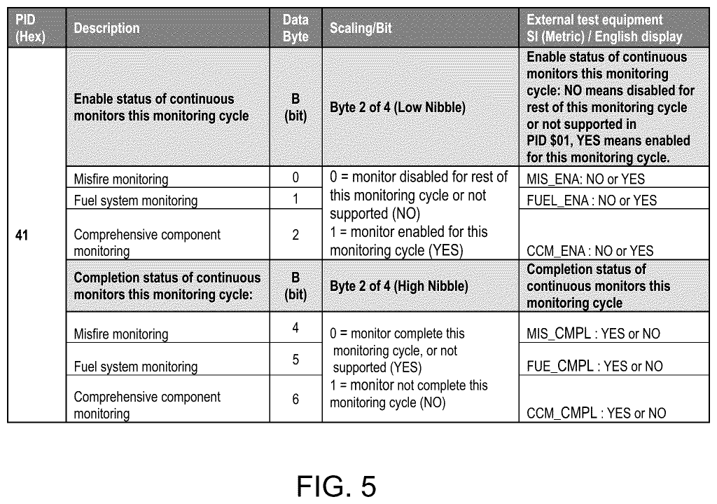

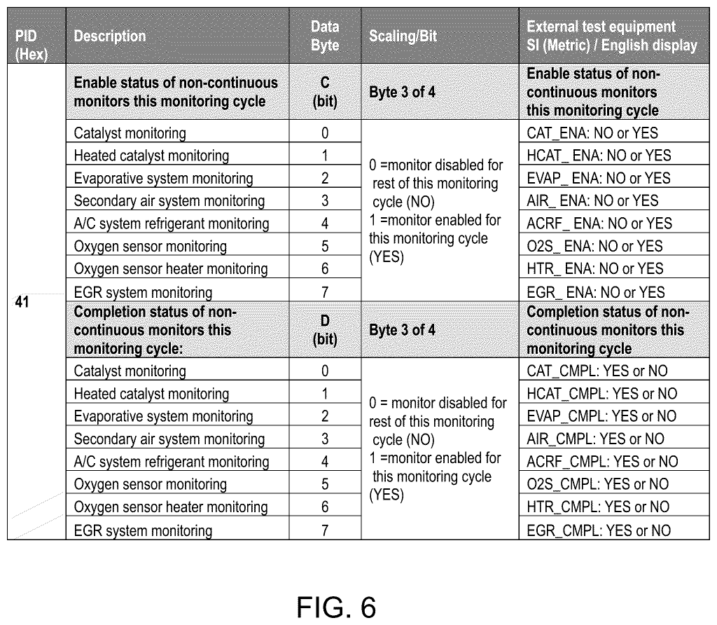

Referring now to FIGS. 1A-1C, there is depicted a flow chart of an exemplary vehicle diagnostic method, while FIG. 2 is a schematic overview of a system 10 associated with the vehicle diagnostic method. A data acquisition and transfer device (DAT) 12 is connectable to a data link connector (DLC) port 14 on a vehicle 16 to facilitate data communication between the vehicle 16 and the DAT 12. FIG. 1A describes the DAT 12 as being plugged into the DLC port 14, although it is contemplated that wireless communication between the DAT 12 and the vehicle 16 may also be employed without departing from the spirit and scope of the present disclosure.

As used herein, the term DAT 12 is broad enough to refer to a scan tool, code reader, dongle, or other electronic device (e.g., smartphone or tablet computer) capable of communicating with the vehicle. The DAT 12 may be sized to be hand-holdable by a user, and may include a connector port that may be connectable to the DLC port 14 on the vehicle 16. The data retrieved through the DLC port 14 may be live data, freeze frame data or stored data in the OBD-II format, or vehicle data formats that are currently in use or may be later developed. The DAT 12 may also have a local display 18 capable of displaying information related to operation of the DAT 12. The DAT 12 may also include a communication circuit capable of communicating data via short-range communications to nearby electronic devices, such as a user's smartphone 19, or via long-range communications to a remote device, such as a remote diagnostic server 20. The communication capabilities of the DAT 12 may include both wired communication as well as wireless communication, e.g., WI-FI, BLUETOOTH, cellular communication, or other wireless communication modalities known in the art.

The smartphone 19 or other computer in communication with the DAT 12 may include an application (“app.”) downloadable thereon to facilitate desired operable compatibility and functionality in combination with the DAT 12. In this regard, the app. may include instructions executable by a processor (of the smartphone 19 or computer) to perform operations associated with the current diagnostic methodology.

The DAT 12 may send a request for OBD2 data to the vehicle 16, and may subsequently receive a data packet or data stream with the requested OBD2 data (e.g., vehicle data), which may include diagnostic data, as well as vehicle identification information (e.g., electronic VIN). The DAT 12 may include a local memory circuit to store data retrieved from the vehicle. The memory circuit may include flash memory, RAM (random-access memory) or other memory hardware known in the art.

The received OBD2 data may be analyzed to identify a possible fault condition or problem with the vehicle 16. The analysis of the OBD2 data may include an analysis of one or more diagnostic trouble codes, live data, freeze frame data, or other data included on the OBD2 data packet or otherwise acquired. The analysis of the OBD2 data may include a comparison of the received OBD2 data to historical OBD2 data of similar vehicles, with the historical data being matched to corresponding problems. The problem(s) associated with the historical data that most closely matches the received OBD2 data may be considered the most likely problem or fault condition. In other embodiments, algorithms or machine learning techniques may be used to identify the most likely problem or fault condition based on the received OBD2 data. For more information regarding the techniques that may be used in the analysis of vehicle data, please refer to the following U.S. patent documents, each of which is owned by Innova Electronics Corporation of Irvine, California: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,068,951, entitled VEHICLE DIAGNOSTIC SYSTEM, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIXED SOLUTION CAPABILITY, U.S. Pat. No. 9,014,908, entitled MULTI-STAGE DIAGNOSTIC SYSTEM AND METHOD, U.S. Pat. No. 9,142,066, entitled MULTI-STAGE DIAGNOSTIC SYSTEM AND METHOD, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 9,824,507, entitled MOBILE DEVICE BASED VEHICLE DIAGNOSTIC SYSTEM, U.S. Pat. No. 10,643,403, entitled PREDICTIVE DIAGNOSTIC METHOD AND SYSTEM, U.S. Pat. No. 11,068,560, entitled METHOD OF PROCESSING VEHICLE DIAGNOSTIC DATA, U.S. Pat. No. 11,270,529, entitled SYSTEM AND METHOD FOR PROACTIVE VEHICLE DIAGNOSIS AND OPERATIONAL ALERT, U.S. Pat. No. 11,158,141, entitled SYSTEM AND METHOD FOR PROACTIVE VEHICLE DIAGNOSIS AND OPERATIONAL ALERT, U.S. Pat. No. 11,915,534, entitled VEHICLE DIAGNOSTICS WITH INTELLIGENT COMMUNICATION INTERFACE, the entire contents of each of which is expressly incorporated by reference herein.

It is contemplated that the identified possible fault condition may be assigned a reliability score or index indicative of a confidence associated with the possible fault condition. The reliability score may be a numerical value that quantifies a confidence in the diagnostic condition that is determined by the system and may be based on, for example, historical data indicative of how often the same diagnostic condition (or other result) was found to be accurate in the same or similar vehicles under the same or similar circumstances in the past and/or the degree of similarity between the vehicle/data acquired and the vehicle/data reflected in the historical data. The method may proceed if the reliability score is above a prescribed threshold, or alternatively, the method may cease or start over if the reliability score is below the prescribed threshold. In this regard, if the confidence in the identified possible fault is low at the outset, further diagnostic analysis reliant on that possible fault may have little value. However, the system may be configured to override a low reliability score if the same fault condition is determined on multiple occasions (e.g., when the method starts over and continues to arrive at the same possible fault condition).

Once the possible fault condition is identified, a drive cycle associated with the possible fault condition may also be identified to confirm a tentative diagnosis, or to conform that a condition has be rectified. In this regard, a database of possible fault conditions matched with one or more drive cycles may be referenced to identify an appropriate drive cycle. The database may be located on the memory circuit of the DAT 12, on a smartphone in communication with the DAT 12, on the vehicle, or on a remote computer, such as a remote server. The identification of the drive cycle may be identified autonomously (i.e., without requiring any user input) in response to identification of a possible fault condition.

The DAT 12 may include a display 18 useful for displaying the drive cycle procedure. It is also contemplated that the drive cycle procedure may be displayed on a display remote from the DAT 12, such as the user's smartphone 19 or the central display screen on the vehicle's infotainment center. In this regard, the DAT 12 or an associated server may send the drive cycle procedure to the smartphone 19 or vehicle infotainment system for depiction on the remote display. Vehicle data may be analyzed during the drive cycle to validate the possible fault condition. For instance, if a particular system or component is associated with the possible fault condition, the vehicle data received during the drive cycle and associated with that particular system or component may deviate from what is expected from a healthy system or component. The analysis of vehicle data to validate the possible fault condition may occur autonomously in response to receipt of the vehicle data. Furthermore, the analysis of vehicle data may occur independent of user input, such that the analysis may be conducted on the DAT 12 or on a remote device, such as the driver's smartphone or via a remote server. In this regard, the driver can remain focused on the road, while the hardware and software associated with the diagnostic system may perform the analysis of the data generated during the drive cycle so as not to distract the driver's attention away from the road.

Using the DAT 12, OBD2 livedata PIDS may be checked to ensure the drive cycle has been completed. If the drive cycle has been completed, the process may continue. On the other hand, if the drive cycle has been interrupted, or has otherwise not been completed, the method may be suspended and autonomously resumed when the interruption ends until the DAT 12 can confirm that the drive cycle has been completed. For more information about performing a drive cycle procedure, please refer to U.S. Pat. No. 11,113,902 entitled ON BOARD DIAGNOSTICS DRIVE CYCLE ADVISOR, owned by Innova Electronics Corporation, and the contents of which are expressly incorporated herein by reference.

Once it is confirmed that the drive cycle has been completed, the DAT 12 may communicate with the vehicle using service $01, PID 41, to check all monitors on the vehicle, including identification of any abnormal monitors in the OBD2 data. Abnormal monitors may include incomplete monitors or disabled monitors. On a spark ignition vehicle (e.g., gas), the monitors may include, but are not necessarily limited to Misfire Monitor, Fuel System Monitor, Comprehensive Component Monitor, Catalyst Monitor, Heated Catalyst Monitor, EVAP System Monitor, Secondary Air System Monitor, Air Conditioning (A/C) Monitor, Oxygen Sensor Monitor, Oxygen Sensor Heater Monitor, Catalyst Monitor, and Exhaust Gas Recirculation Valve (EGR) System Monitor. On compression ignition vehicles (e.g., diesel), the monitors may include, but are not necessarily limited to Misfire Monitor, Fuel System Monitor, Comprehensive Component Monitor, Non-Methan Hydrocarbon Catalyst (NMHC) Monitor, NOx/SCR (Nitrogen Oxide/Selective Catalytic Reduction) Aftertreatment Monitor, Boost Pressure, Exhaust Gas Sensor, PM (Particulate) Filter Monitor, EGR Monitor and/or Variable Valve Timing (VVT) System Monitor.

If there are no abnormal signals from the monitors/sensors, the test may be associated with a passing assessment and other conditions may be considered for further troubleshooting, such as checking for obvious mechanical signs, checking connectors for corrosion, frayed wiring, and damaged pins, and paying attention to any intermittent problems. These conditions may be displayed on the DAT 12, or on a display associated with the DAT 12 or the user, such as on the user's smartphone or computer. A database of possible troubleshooting procedures may provide a ranked listing of troubleshooting possibilities. In accordance with the present disclosure, the ranked listing may be vehicle-specific as well as being location-specific. Similarly, the reliability score may be adjusted based on correspondence of the location of the vehicle under test and the location associated with the vehicles from which the historical data is derived. For instance, vehicles driven in cold climates and exposed to salted roads in wintery conditions may be more prone to experience certain problems than vehicles driven in warm, dry climates. Furthermore, vehicles driven at higher altitudes may experience certain problems that may not be likely in vehicles driven at, or near sea-level.

It is also contemplated that if there are no abnormal signals from the monitors/sensors, all data, monitored conditions, and test results gathered and observed to this point in the process, including vehicle identification information, may be fed into a machine learning model to derive a reliability score, possible troubleshooting options, and/or a ranking listing of troubleshooting possibilities. Further, the user may also be able to input symptomatic information into the machine learning model such that the symptomatic information may be used in the analysis. The symptomatic information may be entered directly into the DAT 12, or alternatively, into a computer or smartphone 18 in communication with the DAT 12, wherein the app. on the smartphone 18 configures the smartphone 18 to facilitate user entry of the symptomatic information, and then forwarding of the entered symptomatic information for use in the analysis.

Referring now specifically to FIG. 1B, if there are abnormal signals from the monitors/sensors, the DAT 12 may use Mode $09, PID 08 and PID OB to check for abnormal values in In-Use Monitor Performance Ratio (IUMPR). IUMPR is a useful data metric for determining the operational frequency of different monitoring strategies under specific drive cycle conditions. IUMPR typically accomplishes this by maintaining two counters: a first counter (e.g., the Conditions Item) that measures the number of times that all conditions necessary for a specific monitor to detect a malfunction have been encountered, and a second counter (e.g., the Completion Item) that measures the number of times that the vehicle has been operated under the specific conditions for the monitor. In other words, IUMPR may refer to the number of monitoring events/number of driving events. The numerator of the ratio corresponds to the first counter, while the denominator represents the second counter. This enables the calculation of the IUMPR for the specific monitor. The implementation of Mode $09, PID 08 and/or PID OB, and/or calculation of IUMPR may proceed autonomously in response to specified conditions, such as the receipt of abnormal signals from the monitors/sensors, which may be informed by machine learning

To ensure accuracy, the collected IUMPR ratio data may be subject to minimum frequencies that vary based on the engine's model year and other factors, which may also be informed by machine learning. These minimum frequencies help document whether or not particular monitoring strategies have successfully assessed the performance of components/systems since the vehicle's OBD system memory was last cleared. This recorded data, known as “readiness indicators,” may play a crucial role in vehicle inspection and maintenance programs. The IUMPR can be used to autonomously detect a failed Electronic Control Units (ECU) program or tune-up ECU by monitoring abnormality in incrementing of the counter.

The DAT 12 may be configured to detect any abnormal value in the Conditions Item and the Completion Item of the IUMPR data. An abnormal value may be an unexpected value or a value that deviates from an expected value by a prescribed amount (e.g., deviation of 10%, 20%, etc.). According to one embodiment, the abnormal value may be based on values/ranges set by the OEM for that monitor, component or system. Furthermore, the abnormal value/ranges may be set by the technician or the company conducting the diagnostics. The abnormal value may also be based on historical Conditions Item values and Completion Item values that were determined to be abnormal in similar vehicles. This determination may be made based on the professional experience of the mechanic, or based on symptoms of the vehicle that were believed to be correlated to an abnormal value in the Conditions Item and/or the Completion Item. It is also contemplated that the abnormal value may be determined by machine learning/artificial intelligence module, which can learn normal values and abnormal values based on data fed into the machine learning/artificial intelligence resource. For instance, vehicle data associated with normal values, as may be determined by an OEM, mechanic, etc., as well as vehicle data associated with abnormal values may be fed into a machine learning module to enable the machine learning module to allow the machine learning module to learn how and when to identify normal values and abnormal values from data retrievable from the vehicle.

If the Conditions Item and the Completion Item values related to the disabled monitor are abnormal, that could be an indication of a problem with the ECU, which may require reprogramming of the ECU to a latest version. In this regard, certain embodiments of the DAT 12 may be capable of autonomously initiating a request for a software update for the ECU. This may entail sending a signal to the ECU to implement preprogrammed software update procedures, or facilitating the download of the software update using other communication resources, such as the user's smartphone or tablet computer. On the other hand, if the Conditions Item and Completion Item values related to the disabled monitor are normal, there could be problems with the component and system.

The monitors that may be supported in Mode $09, PID 08-IUMPR may include, but is not necessarily limited to, OBD Monitoring Conditions Encountered Counts, Ignition Counter, Catalyst Monitor Completion Counts Bank 1, Catalyst Monitor Conditions Encountered Counts Bank 1, Catalyst Monitor Completion Counts Bank 2, Catalyst Monitor Conditions Encountered Counts Bank 2, O2 Sensor Monitor Completion Counts Bank 1, O2 Sensor Monitor Conditions Encountered Counts Bank 1, O2 Sensor Monitor Completion Counts Bank 2, O2 Sensor Monitor Conditions Encountered Counts Bank 2, EGR Monitor Completion Condition Counts, EGR Monitor Conditions Encountered Counts, AIR Monitor Completion Condition Counts (Secondary Air), AIR Monitor Conditions Encountered Counts (Secondary Air), EVAP Monitor Completion Condition Counts, and EVAP Monitor Conditions Encountered Counts.

If there do not appear to be any abnormal IUMPR items, the DAT 12 may autonomously use Mode $06 to check for fail monitor ID (OBDMID) and Test ID (TID). OBDMID may refer to what is being tested, while the TID may refer to what specific test is being run. Mode $06 may allow access to the results of on-board diagnostic monitoring tests of vehicle systems or components. These systems or components can be either continuously monitored (e.g., misfire monitoring) or non-continuously monitored (e.g., catalyst system). Continuous monitors may run all the time while the non-continuous monitors may run only after certain conditions are met. By checking Mode $06, the DAT 12 can detect the status of test values of each component or system (OBDMID and the TID). If the DAT 12 detects any fail in test result, the issue could be the component or sensor under test. The components and systems that can be tested in Mode $06 may include, but are not limited to Exhaust Gas Sensor Monitor, Catalyst Monitor, EGR Monitor, VVT Monitor, EVAP Monitor, Exhaust Gas Sensor Heater Monitor, Heated Catalyst Monitor, Secondary Air Monitor, Fuel System Monitor, Boost Pressure Control Monitor, NOx Adsorber Monitor, NOx/SCR Catalyst Monitor, Misfire Cylinder Data, and PM Filter Monitor.

The Mode $06 function may enable monitoring, which may allow for autonomous detection of degrading performance of the component to predict the faults that may be occurring with the vehicle, or it can be used as a factor to detect the vehicle heath. In this regard, analysis of the data accessible via Mode $06 may allow for identification of diagnostic trends for the monitored component, which may be implemented through machine learning resources. Based on the information available via Mode $06, the component and/or system that may be faulty may be autonomously verified and displayed or otherwise communicated to the user. This may help the user focus on a certain component(s) and/or system(s) to check. In some cases, the vehicle may be experiencing symptoms such as lost power, or excessive fuel consumption, and the Readiness Monitors may not be completed, despite the driver driving the vehicle in accordance with the drive cycle needed to complete the readiness monitors. Furthermore, there may not be any DTCs that are generated to obtain any insight into a problematic component or system. In that instance, Mode $06 may be used to detect a faulty or degrading component or system.

It is contemplated that any diagnostic trend-type data gathered during the process, such as the Mode $06 data as described above, may be useful as an input to a machine learning model. In this regard, the machine learning model may be capable of identifying a possibly faulty system or component based on the trends embodied in the data, in combination with other data and information that may be available.

When retrieving information in Mode $06, the DAT 12 may detect the test value of each OBDMID and the TID. The DAT 12 may also lookup in a database to obtain a translation of each OBDMID and TID that may be understandable by the user. If the DAT 12 detects any fail in test result, the issue could be the component or sensor associated with the test, and the DAT 12 may display the failure OBDMID and TID with the test value and status to the user.

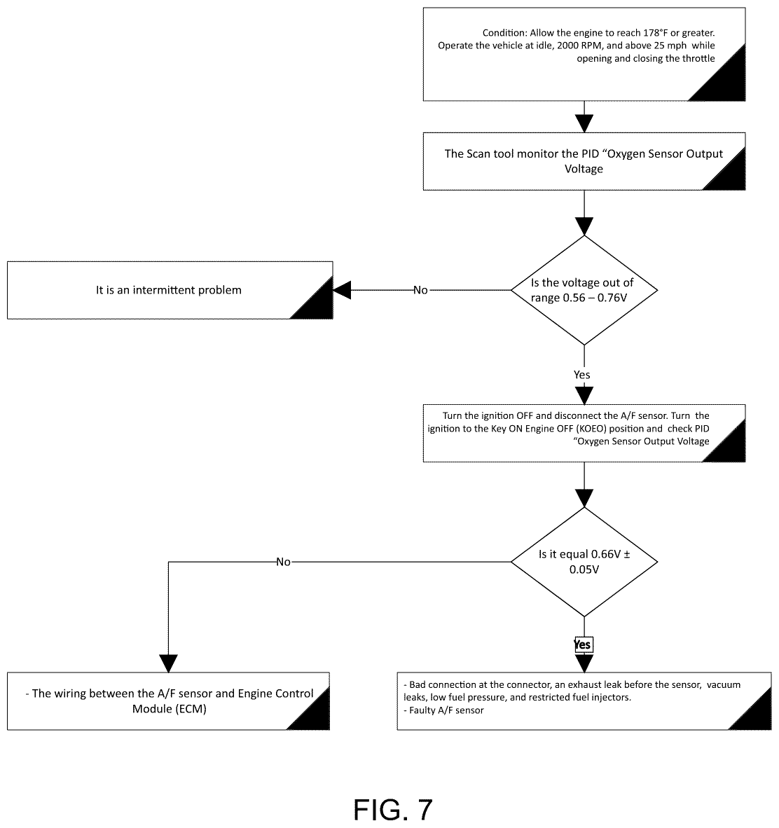

In the event of a detected fail, the DAT 12 may autonomously prompt the user to initiate an OBD2 Special Test to test the component, as indicated in FIG. 1C. The OBD2 Special Test uses the OBD2 PIDs live data to monitor the operation of the component while the vehicle is operating and it compares the actual value with the specification value. In this regard, the Special Test allows for detecting the status of the component. For instance, FIG. 7 is a flow chart associated with a Special Test to check the Air Fuel Ratio Sensor (A/F sensor) status. In some embodiments, the DAT 12 can be configured to autonomously initiate the OBD Special Test in response to a detected fail.

Exemplary Special Tests include, but are not limited to, Long Term Fuel Trim Test, MAF Sensor Test, MAP Sensor Test, Catalytic Efficiency Test, EVAP Test, and EGR Test.

If the DAT 12 detects that all the test results are passing, the DAT 12 may generate a display to inform the user to check the conditions such as engine coolant temperature, ambient air temperature, barometric pressure that may not meet the condition for the test, or the monitor may have exceeded the maximum test attempts.

If there is no fail, the condition of operation is not correct, and thus, the vehicle may need to be driven in the required conditions and checked again. In other words, the component may work well after the evaluation process, however, the monitor of the component may still not be completed. Common examples of when this may occur include an engine-off soak being not long enough (e.g., cold start temperature conditions not satisfied), monitor maximum time limit or number of attempts/aborts exceeded, ambient air temperature too low or too high; pressure too low (high altitude), monitor disabled due to sensor failure.

If there is a fail, then the DAT 12 may detect the component or system that has failed. In this regard, the data from the vehicle may include parameter values for a suspected faulty component. The received parameter values and expected parameter values may be displayed and compared to each other.

After the test, the ECU may respond to the DAT 12 with the status of the component or system. The operational status of the component may be observed and any received value of component parameters may be compared with an expected value. If the received value does not conform with the expected value, a conclusion may be made that the component is faulty. If the received value does conform with the expected value, a conclusion may be made that the component is not faulty.

Furthermore, the component or system can be inspected more efficiently when the DAT 12 can detect the vehicle information and have the database of (Original Equipment Manufacturer) OEM Active Test and Special Function. The DAT 12 can inspect the component deeply and have more live data to compare to detect the faulty component or system.

### EXAMPLE

The vehicle: 2015 Honda Fit L4, 1.5 L

Status: The Monitors: Oxygen sensor monitoring, and Oxygen sensor heater monitoring have status of Incomplete

Follow the Drive Cycle to drive the vehicles:
1. Turn the ignition switch ON; do not start the engine. The MIL will come on for 15-20 seconds. If it goes OFF, readiness codes are Complete. If it blinks several times, one or more readiness codes are Incomplete.
2. Connect a scan tool to the data link connector and select generic mode.
3. Start engine.
4. Drive under stop and go conditions with short periods of steady cruises. During the drive, decelerate with throttle fully closed, for 5 seconds.
5. The readiness code should switch to complete in about 3.5 miles.
6. If the readiness code is still Incomplete, check for a temporary DTC.
7. If no DTC is present, one or more of the enabling criteria were probably not met. If the ECT (Engine Coolant Temperature) is lower than 140 degrees F., run the engine until the ECT (Engine Coolant Temperature) exceeds 140 degrees F., and repeat the test.

After completing the Drive Cycle but there are some monitors that cannot be completed, Monitor status in This Drive Cycle:

| Monitors | Status |
|---|---|
| Misfire monitoring | Complete |
| Fuel system monitoring | Complete |
| Comprehensive component | Complete |
| monitoring | |
| Oxygen sensor monitoring | Disable |
| Oxygen sensor heater monitoring | Disable |
| EGR system monitoring | Complete |

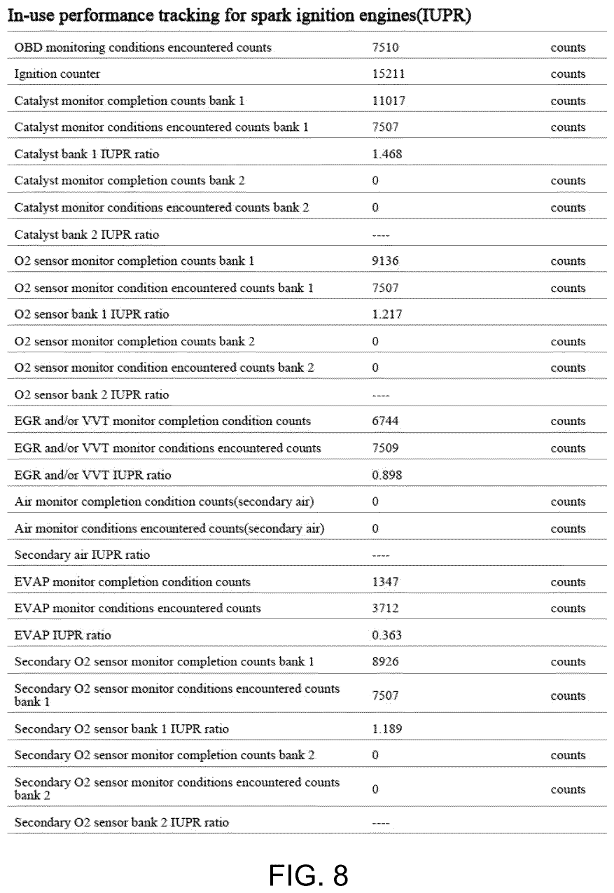

Access Mode $09 PID 08 to check and monitor the IUMR while driving the vehicle with many ignition key ON/OFF Cycles: All the monitor work normally, the value of counter and complete increase normally. It means that the ECU works normally. See FIG. 8.

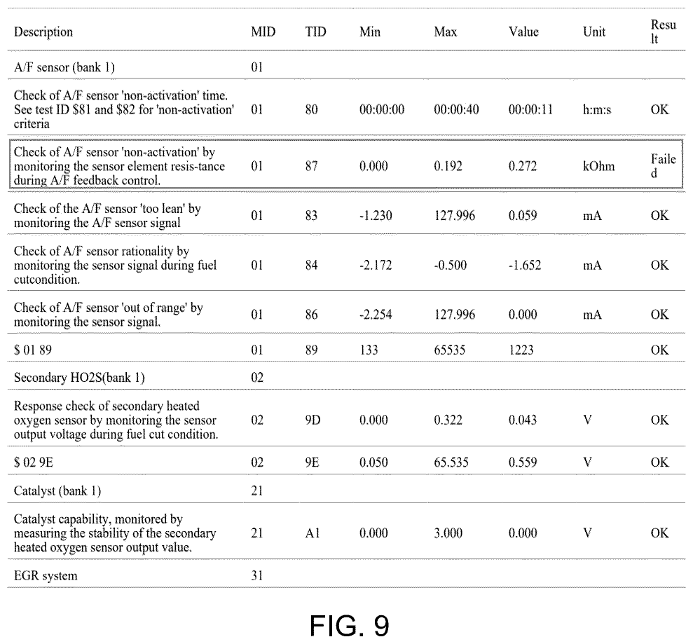

Access Mode $06 to check the status of MID and Test ID, we found there is a failure in result of test of the component: Check of A/F sensor ‘non-activation’ by monitoring the sensor element resistance during A/F feedback control. See FIG. 9.

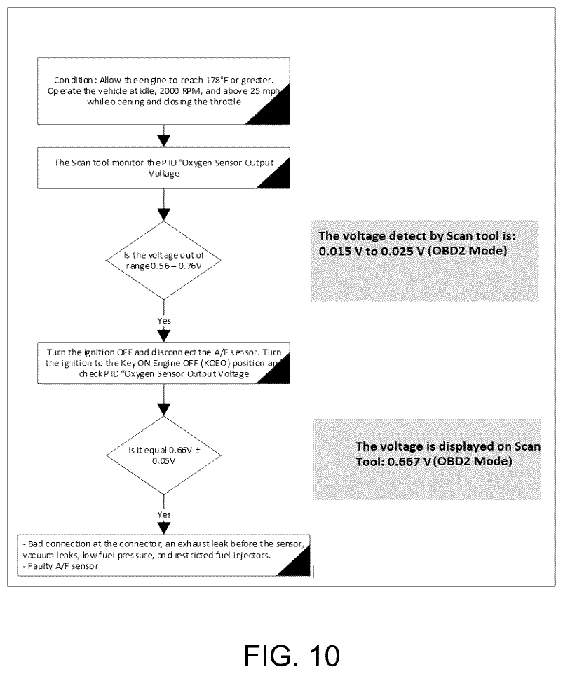

Using the OBD2 Special Test to check the A/F sensor. See FIG. 10.

As the result, the Scan Tool shows that the A/S Sensor is faulty.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An automotive diagnostic method aimed at focusing diagnostic data retrieval and analysis on a possible fault condition, the method comprising the steps of:
receiving vehicle data from a vehicle;
analyzing the vehicle data to identify a possible fault condition;
identifying a drive cycle associated with the identified possible fault condition;
monitoring driving conditions to identify completion of the identified drive cycle;
upon completion of the identified drive cycle, analyzing vehicle data to identify an abnormal monitor; and
analyzing vehicle data to identify an abnormal value of In-Use Monitor Performance Ratio (IUMPR) associated with the abnormal monitor;
when an abnormal value of IUMPR is identified, identifying a likely diagnostic condition associated with the identified abnormal IUMPR.

2. The method recited in claim 1, wherein when a normal value of IUMPR is identified, further comprising the step of retrieving Mode $06 data.

3. The method recited in claim 2, further comprising the step of reviewing the Mode $06 data for an abnormal test result and identifying the component associated with the abnormal test result.

4. The method recited in claim 3, further comprising the step of initiating a Special Test for the component associated with the abnormal test result.

5. The method recited in claim 1, wherein the step of analyzing vehicle data to identify a possible fault condition is based on an analysis of at least one diagnostic trouble code (DTC) included in the received vehicle data.

6. The method recited in claim 1, wherein the step of analyzing vehicle data to identify a possible fault condition is based on an analysis of live data included in the received vehicle data.

7. The method recited in claim 1, wherein the step of analyzing vehicle data to identify an abnormal value of IUMPR includes analyzing a conditions item portion of IUMPR.

8. The method recited in claim 1, wherein the step of analyzing vehicle data includes using a machine learning model, wherein vehicle data is entered into the machine learning model to produce the possible fault condition.

9. The method recited in claim 1, wherein the step of analyzing vehicle data occurs at a data acquisition and transfer device (DAT).

10. The method recited in claim 1, wherein the step of analyzing vehicle data to identify an abnormal value of IUMPR includes analyzing a completion item portion of IUMPR.

11. The method recited in claim 1, further comprising the step of analyzing the received diagnostic data to identify at least one of a monitor ID and test ID when no abnormal IUMPR is identified.

12. The method recited in claim 1, wherein the step of analyzing the vehicle data to identify a possible fault condition occurs at a data acquisition and transfer device (DAT).

13. The method recited in claim 1, wherein all steps following the receipt of vehicle data occur autonomously in response to receipt of the vehicle data.

14. The method recited in claim 1, wherein all steps following completion of the identified drive cycle occur autonomously in response to identification of the completed drive cycle.

15. The method recited in claim 1, wherein the step of analyzing vehicle data to identify the abnormal value of IUMPR occurs autonomously in response to identification of the abnormal monitor.

16. The method recited in claim 1, further comprising the step of generating a signal for wireless communication to a remote electronic device, the signal including the identified likely diagnostic condition.

17. The method recited in claim 1, further comprising the step of assigning a reliability score to the possible fault condition.

18. The method recited in claim 17, wherein the steps of identifying the drive cycle and monitoring driving conditions only occur if the reliability score is above a prescribed threshold.

19. The method recited in claim 17, wherein the step of assigning the reliability score is based on a comparison of the received vehicle data to historical vehicle data for similar vehicles.

20. The method recited in claim 19, further comprising the step of adjusting the reliability score based on a degree of similarity between the vehicle and a historical vehicle from which the historical vehicle data is derived.

21. The method recited in claim 19, further comprising the step of adjusting the reliability score based on a degree of similarity between the vehicle data and the historical vehicle data.

22. The method recited in claim 1, wherein the vehicle data is received at a data acquisition and transfer device (DAT).

23. An automotive diagnostic method aimed at focusing diagnostic data retrieval and analysis on a possible fault condition, the method comprising the steps of:
identifying a drive cycle associated with the identified possible fault condition;
monitoring driving conditions to identify completion of the identified drive cycle;
upon completion of the identified drive cycle, analyzing vehicle data to identify an abnormal monitor; and
analyzing vehicle data to identify an abnormal value of In-Use Monitor Performance Ratio (IUMPR) associated with the abnormal monitor;
when an abnormal value of IUMPR is identified, identifying a likely diagnostic condition associated with the identified abnormal IUMPR.

24. The method recited in claim 23, further comprising the step of assigning a reliability score to the possible fault condition.

25. The method recited in claim 24, wherein the steps of identifying the drive cycle and monitoring driving conditions only occur if the reliability score is above a prescribed threshold.
